(19) United States
(12) Patent Application Publication
(10) Pub. No.: US 2007/0085335 A1
(43) Pub. Date: Apr. 19, 2007

(54) METHOD OF INCORPORATING TAGGANTS INTO A PACKAGING BLANK

(76) Inventor: Scott A. Lampe, Grand Haven, MI (US)

Correspondence Address: SUMMA, ALLAN & ADDITON, P.A., 11610 NORTH COMMUNITY HOUSE ROAD, SUITE 200, CHARLOTTE, NC, 28277, US

(21) Appl. No.: 11/533,977

(22) Filed: Sep. 21, 2006

Related U.S. Application Data
(60) Provisional application No. 60/720,394, filed on Sep. 26, 2005.

(51) Int. Cl. B42D 15/00

(52) U.S. Cl. 283/74

(57) ABSTRACT

A method of incorporating taggants into a packaging blank or blanks wherein an adhesive compound used to seal a container formed from the blank includes a taggant incorporated therein such that the doped adhesive compound facilitates the authentication of the container. The invention further provides a packaging blank or blanks having a doped adhesive compound positioned on selected portions of the blank such that taggants in the doped adhesive compound function to authenticate the blank or container formed from the blank.

### CROSS-REFERENCE TO PRIORITY APPLICATIONS

This application hereby claims the benefit of the following commonly assigned provisional patent application U.S. Provisional Patent Application Ser. No. 60/720,394 for A Method of Incorporating Taggants into a Packaging Blank, filed Sep. 26, 2005. This application incorporates entirely by reference this provisional application.

### FIELD OF THE INVENTION

The invention relates to a method of constructing a container. In particular, the invention relates to a method of incorporating taggants and other chemical identifiers into one or more packaging blanks wherein an adhesive compound used to seal a container formed from the blank includes a taggant incorporated therein such that the doped adhesive compound facilitates the authentication of the container. The invention further relates to a packaging blank having a doped adhesive compound positioned on selected portions of the one or more blanks such that taggants in the doped adhesive compound function to authenticate the blank or container formed from the one or more blanks.

### BACKGROUND OF THE INVENTION

As known to those skilled in the art, packaging is typically formed from packaging blanks, or blanks for short. It will be understood that as used herein the term “blank” may include cardboard, rigid paper, flexible plastic, or similar products made of paperboard or plastic. In particular, the packaging industry favors the use of one-piece flexible blanks, which are readily incorporated into automated processes for forming containers.

Industries reliant upon packaging routinely experience problems with counterfeiting which results in the loss of millions of dollars of revenue each year. Worldwide estimates indicate that over $200 billion a year are lost due to counterfeiting. The packaging industry has adopted a number of overt and covert security features to prevent counterfeiting, but most of these features address tampering and are expensive. Few of these security features provide an economical and reliable means for authenticating a particular package or product contained therein.

The available authentication features are typically applied to exterior surfaces of the packaging in the form of films, labels, or ink coatings. Unfortunately, application of the authentication features to exterior surfaces of the packaging provides the counterfeiter with access to the features, thereby increasing the likelihood that counterfeiters will attempt to manipulate exposed features in an effort to subvert detection of non-authenticated goods. Accordingly, it is desirable to provide an authentication feature that is concealed within or incorporated into a container formed from a packaging blank.

It is known to use taggants in products to identify, for example, the source of a manufacturer or to authenticate a particular product. As used herein, the term “taggants” refers to any of various substances, such as phosphors, added to a product to indicate its source of manufacture (i.e., to authenticate its origin). Typical uses for taggants include incorporating the taggants into ink and applying the ink to exterior surfaces of a package.

Further uses include applying taggants onto a substrate, such as a laminate or film covering portions of packaging. For example, U.S. Pat. No. 6,085,903 to Jotcham et al. discloses a packaging blank having a security feature (e.g., fibers, embedded security threads circuits, and taggants) incorporated therein and a method for the same. Specifically, Jotcham describes a paperboard blank formed from a plurality of substrates that are laminated together to form an integral sheet. According to Jotcham, the substrates may include security paper and a backing layer of boxboard. The multiple substrates forming the blank of Jotcham are laminated together by means of an adhesive containing a security feature (e.g., taggants). As described, Jotcham teaches the use of an adhesive containing taggants to secure (i.e., laminate) a plurality of substrates together to form the blank. Further, Jotcham discloses a method of making a counterfeit resistant security package comprising the steps of forming a sheet of rigid material, cutting at least one blank from the sheet, and assembling a security package from the blank, wherein a security feature is partially embedded within the rigid material.

In contrast, the present method incorporates taggants into an adhesive compound and then selectively applies the doped adhesive compound onto any number of areas of the packaging blank in a functional process of constructing the container. In other words, the present method applies the doped adhesive compound onto exterior surfaces of a blank as part of the functional construction the container, whereas Jotcham incorporates the adhesive into a layer that secures substrates together to form the blank (i.e., not the container).

U.S. Pat. No. 6,165,609 to Curatolo discloses a label containing a substrate layer and a security coating formed on a least one side of the substrate layer and a method of making a security label. Curatolo specifically teaches the steps of applying a security coating that contains a film forming material and a taggant compound onto a substrate layer to form a label. This label is then affixed to any number of articles. In contrast, the present method incorporates taggants into an adhesive compound to form a doped adhesive compound and then applies the doped adhesive compound to panels and flaps of a blank during construction of a container. In other words, Curatolo teaches the use of a taggant in a label coating for placement on a container, whereas the present method applies a doped adhesive compound containing a taggant in a functional manner during construction of the container.

These applications require distinct and separate steps during the in-line processing of, for example, a packaging blank to form a container. Thus, it is desirable to provide a method wherein taggants are incorporated into an adhesive compound to form a doped adhesive compound, such that the doped adhesive compound is applied to the packaging blank during the normal construction of a container without requiring additional steps.

It is also desirable to provide a method for incorporating a doped adhesive compound containing taggants into the construction of a container to thereby secure panels and flaps of a blank.

It is further desirable to provide a method of integrating the steps of applying an adhesive compound to a blank for the purpose of constructing a container and incorporating taggants into a blank for the purpose of authentication.

Is also desirable to provide a method for incorporating a taggant into an adhesive compound at the manufacturer's facility so that the manufacturer may supervise application of the doped adhesive compound. This minimizes potential tampering with the packaging once the packaging leaves the manufacturer's facility.

Still further, it is desirable to provide a doped adhesive compound that includes a minimal amount of taggant to thereby reduce the cost of manufacturing a container that is capable of authentication.

### OBJECT AND SUMMARY OF THE INVENTION

It is therefore an object of the present invention to provide an authentication feature that is concealed within or incorporated into a container formed from one or more packaging blanks.

Another object of the invention is the provision of a method wherein taggants are incorporated into an adhesive compound to form a doped adhesive compound, such that the doped adhesive compound is applied to one or more packaging blanks during the normal construction of a container without requiring additional steps.

A further object of the invention is to provide a method of incorporating a doped adhesive compound containing taggants into the construction of a container to thereby secure panels and flaps of one or more packaging blanks.

Yet a further object is to provide a method of integrating the steps of applying an adhesive compound to one or more packaging blanks for the purpose of constructing a container and incorporating taggants into one or more packaging blanks for the purpose of authentication.

Still another object is the provision of a method for incorporating a taggant into an adhesive compound at the manufacturer's facility so that the manufacturer may supervise application of the doped adhesive compound.

Yet another object of the invention is to provide a doped adhesive compound that includes a minimal amount of taggant to thereby reduce the cost of manufacturing a container that is capable of authentication.

The invention meets these objectives with a method of incorporating taggants into one or more packaging blanks. In particular, the invention is a method of incorporating taggants into one or more packaging blanks comprising the steps of providing a packaging blank that is capable of forming a container, incorporating taggants into an adhesive compound to thereby form a doped adhesive compound, and applying the doped adhesive compound to selected portions of the one or more packaging blanks. The invention further meets these objectives with one or more packaging blanks for forming a container that is capable of authentication, having a plurality of edges and one or more fold lines, and a doped adhesive compound applied thereto comprising homogenously dispersed taggants, wherein the taggants function to authenticate the one or more packaging blanks or the container formed from the one or more packaging blanks.

The foregoing and other objects and advantages of the invention and the manner in which the same are accomplished will become clearer based on the following detailed description taken in conjunction with the accompanying drawings in which:

### BRIEF DESCRIPTION OF THE DRAWINGS

FIG. 1 is a top plan view of an embodiment of an exemplary packaging blank.

FIG. 2 is a perspective view of a container formed from the packaging blank of FIG. 1.

FIG. 3 is a top plan view of another embodiment of an exemplary packaging blank.

FIG. 4 is a perspective view of a container formed from the packaging blank of FIG. 3.

FIG. 5 is a perspective view of a container formed from the packaging blanks of FIGS. 1 and 3.

### DETAILED DESCRIPTION OF THE INVENTION

The present invention will now be described more fully hereinafter with reference to the accompanying drawings, in which a preferred embodiment of the invention is shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Further, it will be understood that the term “adhesive” and “adhesive compound” refers to any substance, inorganic or organic, natural or synthetic, that is capable of bonding other substances together by surface attachment. Adhesives are typically classified as inorganic or organic. Briefly, inorganic adhesives include soluble silicates, phosphate cements, ceramic, and thermosetting powdered glasses. Organic adhesives are categorized as natural or synthetic. Natural adhesives may include animal adhesives (e.g., hide glue, bone glue, and casein glues) and vegetable adhesives (e.g., rubber latex, gums, and terpene resins). Synthetic adhesives may include elastomer-solvent cements, thermoplastic resins, and thermosetting resins. Those skilled in the art will appreciate that casein glues are commonly referred to as “white glues” that describe any of a number of water-based casein glues, almost all of which are white (hence the name). More specifically, casein is a phosphoprotein of milk that is precipitated from milk by heating with an acid or by the action of lactic acid in souring and is commonly used in making paints and adhesives. Casein glues are commonly used for joining porous materials such as paper and wood. Advantageously, casein glues are inexpensive, reasonably strong, non-toxic, odorless, nonflammable, and dry clear in under an hour.

Those skilled in the art will appreciate that “phosphor” refers to a substance, either organic or inorganic, liquid or crystals, that is capable of luminescence (i.e., capable of absorbing energy from sources such as x-rays, cathode rays, or ultraviolet (UV) radiation and emitting a portion of the energy in the UV, visible, or infrared spectrum). Thus, a luminescent substance emits light when excited by radiation. It will also be understood that material that continues to emit light for a period of time after the removal of the exciting energy is said to be “phosphorescent.”

That said, it will be understood that “phosphorescence” is a type of luminescence in which the emission of radiation resulting from excitation of a crystalline or liquid material occurs after excitation has ceased and may last from a fraction of a second to an hour or more. In other words, phosphorescence is a type of luminescence that is caused by the absorption of radiation at one wavelength followed by delayed reradiation at a different wavelength and that continues for a noticeable time after the incident radiation stops.

In comparison, “fluorescence” refers to a type of luminescence in which an atom or molecule emits visible radiation in passing from a higher to a lower electronic state. The term is restricted to phenomenon in which the time interval between absorption and emission of energy is extremely short. This distinguishes fluorescence from phosphorescence, in which the time interval may extend to several hours. Fluorescent materials may be liquid or solid, organic or inorganic. In other words, fluorescence is a type of luminescence that is caused by the absorption of radiation at one wavelength followed by nearly immediate reradiation usually at a different wavelength and that ceases almost at once when the incident radiation stops.

Those skilled in the art will appreciate that the terms “room temperature” or “ambient temperature” refers to temperatures in the range of between about 19° C. and 27° C. As described herein, in one embodiment of the present method, taggants may be mixed and applied to a blank at about room temperature to form a manufacturer's glue joint upon construction of a container formed from the blank.

It will be understood that the term “hot melt adhesives” refers to adhesives that may be applied at or above 150° C. In another embodiment of the present method, the doped adhesive compound may be heated and applied as a hot melt adhesive to the closure flaps (e.g., top and bottom flaps of a blank) at, for example, the carton filling location.

As used herein, the term “detector” may refer to any number of instruments that are capable of determining the presence of some physical quantity and responding usually with a transmitted signal. For example, a light detector will operate such that infrared (IR) light causes the taggant to phosphorus. When a carton is sealed, a tiny portion of glue extends beyond the glue flap. When radiated, the IR light excites the taggant which is visible under the IR light. As another example, an audio detector will operate such that IR light irradiates a taggant and then receives emissions from the taggant which cause the detector to create an audible sound.

The term “doped” as used in connection with “adhesive compound” refers to any of various additive substances or liquid preparations introduced into the adhesive compound to contribute a desired quality. Accordingly, the term “undoped” as used in connection with “adhesive compound” refers to the absence of various additive substances or liquid preparations in the adhesive compound.

It will also be understood that the term “homogenous” will refer to a substance or compound of uniform structure or uniform composition throughout. Stated differently, the term homogenous refers to a substance or compound showing no variation.

As used herein, the term “substantially coextensive” will refer to a substance or compound having the same spatial or temporal scope, or the same boundaries. Further, the term “coterminous” will refer to a substance or compound having the same or coincident boundaries.

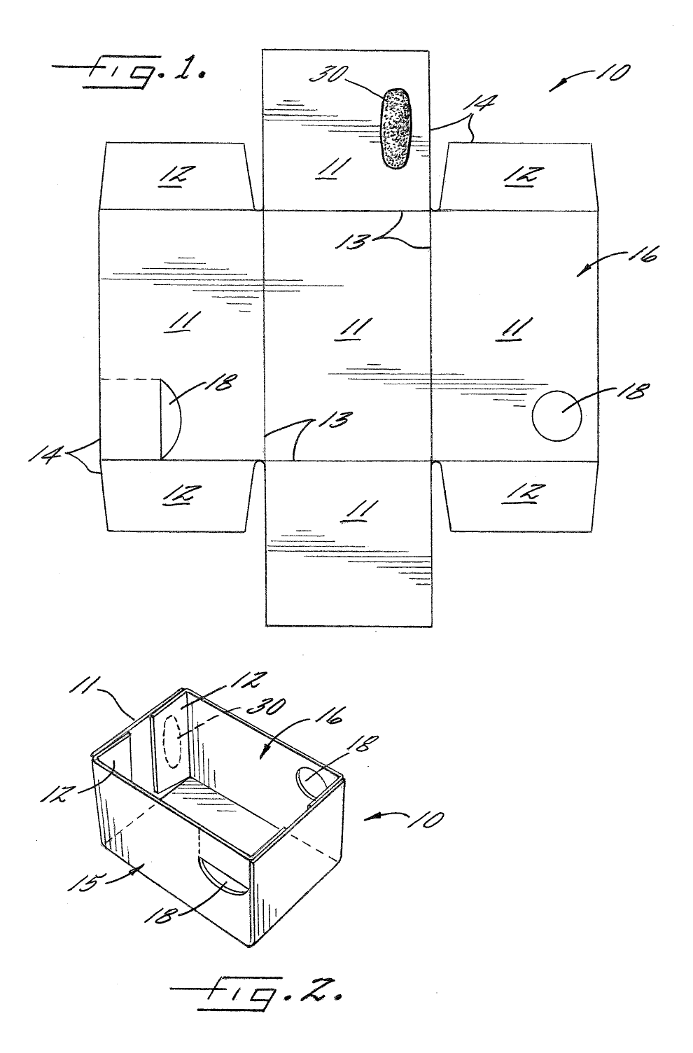

The term “panel” is used in conjunction with the packaging blank of the present invention and refers to sections of the blank. With reference to the orientation of the blank in FIG. 1, it will be understood that the term “width” refers to a distance measured from the leftmost portion of the first side panel to the rightmost portion of the second side panel. Further, it will also be understood by those of skill in the art that as used herein, the concept of a panel being “between” two other panels does not necessarily imply that the three panels are contiguous (i.e., in intimate contact). Rather, as used herein, the concept of one panel being between two other panels is meant to describe the relative positions of the panels within the blank structure, respectively.

Furthermore, as used herein, it will be understood that the term “article” will refer primarily to consumer products that are packaged for shipment (e.g., consumables, bottles, cans, etc.). It will be understood, however, that “article” may also refer to any number of goods such as individually packaged consumables for humans and animals, as well as individually packaged non-consumables.

It will be understood by those skilled in the art that the terms “container” and “carton” as used herein refer to various embodiments of the present structure for retaining a variety articles as formed from the various embodiments of the blank described below. Thus the terms “container” and “carton” may be used interchangeably.

Similarly, the concept of a first panel being connected to a second panel by a third panel, “opposite” the second panel, merely describes the relative positions of the first and second panels within the blank structure. It will further be understood that the term “finished” means coated with a material to produce an attractive glossy finish. The term “finished” will also be understood to mean the inclusion of printed material or other identifying indicia (e.g., a company's logo).

The terms “flap” or “closure flap” refers to one of the closing members of a folding carton or container. Those skilled in the art will also appreciate that panels include edges defined as the line of intersection of two surfaces or a border.

It will be understood that the term “manufacturer's joint” refers to the mechanical connection between two panels to create a container. Typically, a joint is comprised of a flap and an adhesively secured overlying panel.

It will be understood by those skilled in the art that the term “score” refers to a crease along which the adjacent elements of the blank are folded without cracking or breaking to form a container. It will also be understood by those skilled in the art that the term “cut-score” refers to an impression formed by a cutting tool (e.g., a punch, die, or blade) that extends partially through a sheet of paperboard or the like. It will be understood by those skilled in the art that the term “perforations” refers to a series of holes or impressions formed by a cutting tool (e.g., a punch or die) that permits easy separation of, for example, panels. Those skilled in the art will appreciate that the term “combo rule” or “cut and score” refers to a series of alternating impressions formed by a cutting tool and creases formed by a rule that facilitate the folding of panels.

It will be understood that the term “fold line” refers to a line formed by a score or cut score that permits the folding of one panel with respect to another panel of the blank.

It will also be understood that the term “substantially rectangular” and “substantially trapezoidal” is meant to succinctly describe simple geometric shape approximating a rectangle and trapezoid, respectively. Similarly, the term “substantially parallel” is meant to describe the spatial relationship between, for example, one edge of a panel to another edge of a panel, wherein the relationship is approximately parallel.

Those skilled in the art will also appreciate that the term “adjacent” refers to two or more, for example, panels, that have a common border or are in close proximity to one another. Nevertheless, it will be understood that adjacent may or may not imply contact, but always implies the absence of anything of the same kind in between.

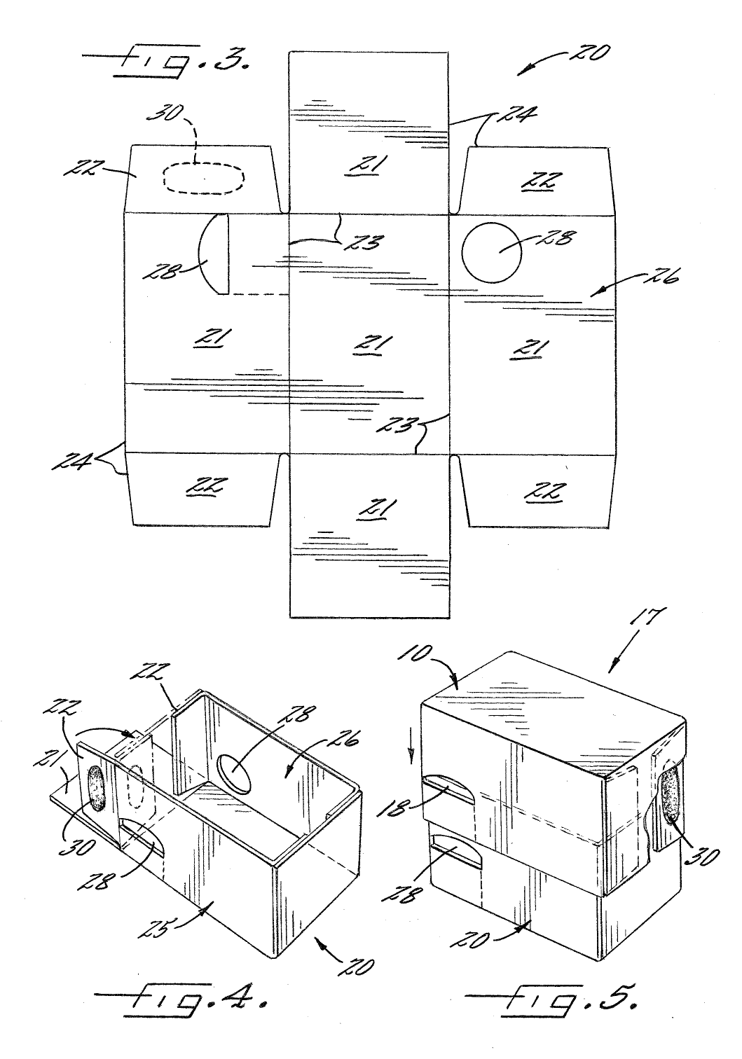

The invention provides for a method of incorporating taggants into one or more packaging blanks 10, 20. In operation, the method provides one or more packaging blanks 10, 20 that are capable of forming a container 17 (see FIG. 5). Referring to FIGS. 1 and 3, the packaging blanks 10, 20 provided include one or more panels 11, 21, one or more flaps 12, 22, one or more fold lines 13, 23, one or more edges 14, 24, and one or more openings 18, 28. In one embodiment the container 17 formed from the blanks 10, 20 is suitable for retaining and dispensing, for example, batteries. It will be understood that the packaging blanks 10, 20 depicted in FIGS. 1 and 2 are merely exemplary embodiments, and this present method may include the incorporation of taggants into any number of packaging blanks having any number of panels, flaps, fold lines, and edges. In one embodiment, the packaging blanks 10, 20 provided are one-piece blanks having an external planar side 15, 25 and an internal planar side 16, 26, wherein the external planar side is finished. It will be understood that the packaging blanks 10, 20 may be formed of paperboard.

Next, taggants are homogenously incorporated into an adhesive compound to form a doped adhesive compound 30 in which the taggants are dispersed within the adhesive compound. In one embodiment, the taggants may comprise phosphor and the doped adhesive compound 30 may consist essentially of casein glue. It will also be understood that taggants may be incorporated into an ink coating or paperboard slurry.

During the incorporation step, the taggants and adhesive compound are mixed at about room temperature (i.e., ambient temperature) to form the doped adhesive compound 30. For example, in one embodiment of the method, the taggants and adhesive compound are mixed at a temperature less than about 29° C. More typically, the taggants and adhesive compound are mixed at a temperature of more than about 19° C. or less than about 27° C., or both (i.e., between about 19° C. and 27° C.).

Upon the incorporation of the taggants into the adhesive compound according to the present invention, the doped adhesive compound 30 generally comprises less than 1.0 weight percent of the taggants (i.e., 10,000 parts per million or “ppm”), such as between about 0.005 and 0.10 weight percent of the taggants (i.e., 50 to 1,000 ppm). In one embodiment, the doped adhesive compound 30 comprises between about 0.05 and 0.50 weight percent of the taggants (i.e., 500 to 5,000 ppm). In a particular embodiment, 45 grams of taggant were mixed with 3.0 gallons of adhesive such that the doped adhesive compound 30 comprises about 0.359 weight percent of the taggants.

In another embodiment, the doped adhesive compound 30 comprises between about 0.10 and 0.50 weight percent of the taggants (i.e., 1,000 to 5,000 ppm). In still another embodiment the doped adhesive compound 30 comprises between about 0.20 and 0.50 weight percent of the taggants (i.e., 2,000 to 5,000 ppm).

Upon incorporating the taggants into the adhesive compound, the doped adhesive compound 30 is then applied to selected portions of the packaging blank or blanks 10, 20 as illustrated in FIGS. 1 and 3. By doing so, the packaging blanks 10, 20 are thereby tagged. In accordance with the present method, the doped adhesive compound 30 is selectively applied to portions of the packaging blank or blanks 10, 20 whereby the taggants and the adhesive compound are substantially coextensive or coterminous with respect to one another.

In one embodiment of the present method, the doped adhesive compound 30 is maintained and applied to the packaging blank 10 at about room temperature. For example, in one embodiment of the method, the doped adhesive compound 30 is maintained and applied to the packaging blanks 10, 20 at a temperature of less than about 29° C. More typically, the doped adhesive compound 30 is maintained and applied to the packaging blank at a temperature of more than about 19° C. or less than about 27° C., or both (i.e., between about 19° C. and 27° C.). In accordance with this particular embodiment, the doped adhesive compound 30 may be referred to as a “cold glue adhesive.” Advantageously, the maintenance and application of the doped adhesive compound 30 at room temperature requires no heating and is thus more economical for manufacturers. In an exemplary method of practicing this invention, the room temperature doped adhesive compound 30 is applied to form a manufacturer's glue joint (see FIGS. 2, 4, and 5).

In another embodiment, the doped adhesive compound 30 is heated and then applied to the packaging blank or blanks 10, 20 at a temperature greater than about 150° C. More typically, the doped adhesive compound 30 is heated and then applied to the packaging blank or blanks 10, 20 at a temperature of between about 145° C. and 175° C. Still more typically, the doped adhesive compound 30 is heated and then applied to the packaging blank or blanks 10, 20 at a temperature of more than about 150° C. or less than about 170° C., or both (i.e., between about 150° C. and 170° C.). Accordingly, the doped adhesive compound 30 heated and then applied at this temperature may be referred to as a “hot melt” doped adhesive compound 30. In yet another exemplary method of practicing the present invention, the hot melt doped adhesive compound 30 may be applied to closure flaps 12, 22 provided on the packaging blanks 10, 20 to seal the container 17 upon filling the container with any number of articles at a fill station along the in-line process.

More specifically, the step of applying the doped adhesive compound 30 to selected portions of the packaging blank or blanks 10, 20 may include directing the doped adhesive compound onto one or more sides 15, 25, 16, 26 of the packaging blanks (see FIGS. 1 and 3). Still more specifically, the step of applying the doped adhesive compound 30 to selected portions of the packaging blank or blanks 10, 20 may also include directing the doped adhesive compound onto one or more panels 11, 21 or one or more flaps 12, 22 such that when the blank is formed into the container 17 the doped adhesive compound as applied to the panels or flaps forms a joint (see FIGS. 2, 4, and 5).

The present method may further include the step of constructing the packaging blank or blanks 10, 20 into a container 17 capable of retaining any number of articles. As a part of constructing the packaging blank or blanks 10, 20 into the container 17, the present method also provides for the step of directing the doped adhesive compound 30 onto selected portions of one or more panels 11, 21 or one or more flaps 12, 22 of the container to thereby permit the sealing of the container 17.

In still another embodiment of the present method, an undoped adhesive compound may be directed onto selected portions of the packaging blank or blanks 10, 20 other than the portions of the blank onto which the doped adhesive compound 30 is applied.

Another aspect of the present invention, as illustrated in FIGS. 1 and 2, includes a packaging blank or blanks 10, 20 for forming a container 17 that is capable of authentication. The packaging blank or blanks 10, 20 include a plurality of edges 14, 24 and one or more fold lines 13, 23. It will be understood that the packaging blanks 10, 20 depicted in FIGS. 1 and 2 are merely exemplary embodiments, and this present method may include the incorporation of taggants into any number of packaging blanks having any number of panels 11, 21, flaps 12, 22, fold lines 13, 23 and edges 14, 24. The fold lines 13, 23 define one or more panels 11, 21 and one or more flaps 12, 22. The fold lines 13, 23 may be formed by perforations, scores, or similar indentations sufficient to permit the folding of the panels 11.

The packaging blank or blanks 10, 20 also include a doped adhesive compound 30 that facilitates the construction and sealing of the container 17. The doped adhesive compound 30 includes homogenously dispersed taggants that function to authenticate the blank or blanks 10, 20 or the container 17 formed from the blank or blanks. The doped adhesive compound 30 is positioned on selected portions of one or more of the panels 11, 21 or one or more of the flaps 12, 22. In one embodiment, the taggants may comprise phosphor and the doped adhesive compound 30 may consist essentially of casein glue.

In one embodiment, the packaging blank or blanks 10, 20 is a one-piece blank having an external planar side 15, 25 and an internal planar side 16, 26, wherein the external planar side is finished. For advertising and promotional considerations, the external planar side 15, 25 is preferably finished (i.e., includes printed material or related identifying indicia). It will be understood that the packaging blank or blanks 10, 20 may be formed of paperboard.

The doped adhesive compound 30 generally comprises less than 1.0 weight percent of the taggants (i.e., 10,000 ppm). For example, in one embodiment, the doped adhesive compound 30 comprises between about 0.005 and 0.10 weight percent of the taggants (i.e., 50 to 1,000). In another embodiment, the doped adhesive compound 30 comprises between about 0.05 and 0.50 weight percent of the taggants (i.e., 500 to 5,000).

In yet another embodiment, the doped adhesive compound 30 comprises between about 0.10 and 0.50 weight percent of the taggants (i.e., 1,000 to 5,000). In still anther embodiment, the doped adhesive compound 30 comprises between about 0.20 and 0.50 weight percent of the taggants (i.e., 2,000 to 5,000).

As a result of the method as described above, the doped adhesive compound 30 is selectively applied to portions of the packaging blank or blanks 10, 20 such that the taggants and the adhesive compound are substantially coextensive with respect to one another. During construction of container 17 formed from the blank or blanks 10, 20, the doped adhesive compound 30 is maintained and applied to the packaging blank or blanks at or about room temperature. For example, in one embodiment of the method, the doped adhesive compound 30 is maintained and applied to the packaging blanks 10, 20 at a temperature of less than about 29° C. More typically, the doped adhesive compound 30 is maintained and applied to the packaging blank at a temperature of more than about 19° C. or less than about 27° C., or both (i.e., between about 19° C. and 27° C.). In one embodiment of the container 17 formed from the blank 10, the doped adhesive compound 30 is applied to the blank or blanks 10, 20 to form the manufacturer's glue joint (see FIGS. 2, 4, and 5).

In another embodiment of the container 17 formed from the blank or blanks 10, 20, the doped adhesive compound 30 is heated and then applied to the packaging blank or blanks at a temperature greater than about 150° C. More typically, the doped adhesive compound 30 is heated and then applied to the packaging blank or blanks 10, 20 at a temperature of between about 145° C. and 175° C. Still more typically, the doped adhesive compound 30 is heated and then applied to the packaging blank or blanks 10, 20 at a temperature of more than about 150° C. or less than about 170° C., or both (i.e., between about 150° C. and 170° C.). For example, the hot melt doped adhesive can be applied to closure flaps 12, 22 to seal the container 17 upon filling at a fill station.

Upon construction, the container 17 formed from the blank or blanks 10, 20 may include one or more joints that are formed when a portion of at least one of the panels 11, 21 is secured to a portion of at least one of the flaps 12, 22 with the doped adhesive compound 30 (see FIG. 5).

In another embodiment of the present blank or blanks 10, 20, an undoped adhesive compound may be directed onto selected portions of the packaging blank other than the portions of the blank onto which the doped adhesive compound 30 is applied.

In the drawings and specification, there have been disclosed typical embodiments on the invention and, although specific terms have been employed, they have been used in a generic and descriptive sense only and not for purposes of limitation, the scope of the invention being set forth in the following claims.

That which is claimed is:

1. A method of incorporating taggants into a packaging blank, said method comprising:
providing a packaging blank that is capable of forming a container, the packaging blank having one or more panels and one or more flaps;
homogenously incorporating taggants into an adhesive compound to form a doped adhesive compound in which the taggants are dispersed therein; and
applying the doped adhesive compound to selected portions of the packaging blank such that the packaging blank is tagged;
wherein the doped adhesive compound is selectively applied to portions of the packaging blank such that the taggants and the adhesive compound are substantially coextensive with respect to one another.

2. A method according to claim 1, wherein the packaging blank consists essentially of a one-piece blank.

3. A method according to claim 2, wherein the one-piece blank has an external planar side and an internal planar side, the external planar side being finished.

4. A method according to claim 1, wherein the packaging blank is comprised of paperboard.

5. A method according to claim 1, wherein the step of incorporating taggants comprises mixing the taggants and adhesive compound at about room temperature to form the doped adhesive compound.

6. A method according to claim 1, wherein the taggants comprise phosphor.

7. A method according to claim 1, wherein the doped adhesive compound consists essentially of casein glue.

8. A method according to claim 1, wherein the doped adhesive compound comprises less than 1.0 weight percent of the taggants.

9. A method according to claim 1, wherein the doped adhesive compound comprises between about 0.005 and 0.10 weight percent of the taggants.

10. A method according to claim 1, wherein the doped adhesive compound comprises between about 0.05 and 0.50 weight percent of the taggants.

11. A method according to claim 1, wherein the doped adhesive compound is maintained and applied to the packaging blank at about room temperature.

12. A method according to claim 1, wherein the doped adhesive compound is heated and applied to the packaging blank.

13. A method according to claim 1, wherein the step of applying the doped adhesive compound comprises directing the doped adhesive compound onto one or more sides of the packaging blank.

14. A method according to claim 1, wherein the step of applying the doped adhesive compound comprises directing the doped adhesive compound onto one or more panels or one or more flaps of the packaging blank such that when the blank is formed into the container the doped adhesive compound as applied to the panels and flaps forms a joint of the container.

15. A method according to claim 1, further comprising the step of constructing the packaging blank into a container.

16. A method of incorporating according to claim 15, further comprising the step of directing the doped adhesive compound onto selected portions of one or more panels or one or more flaps of the container to thereby permit the sealing of the container.

17. A method according to claim 1, further comprising the step of directing an undoped adhesive compound onto selected portions of the packaging blank other than the portions to which the doped adhesive compound is applied.

18. A packaging blank for forming a container that is capable of authentication, said blank comprising:
a packaging blank having a plurality of edges and one or more fold lines, said fold lines defining one or more panels and one or more flaps; and
a doped adhesive compound comprising homogenously dispersed taggants, said doped adhesive compound positioned on selected portions of one or more of said panels or one or more of said flaps, said adhesive compound facilitating the construction and sealing of the container;
wherein said taggants function to authenticate said blank or the container formed from said blank.

19. A packaging blank according to claim 18, wherein said packaging blank consists essentially of a one-piece blank.

20. A packaging blank according to claim 19, wherein said one-piece blank has an external planar side and an internal planar side, said external planar side being finished.

21. A packaging blank according to claim 18, wherein said packaging blank comprises paperboard.

22. A packaging blank according to claim 18, wherein said doped adhesive compound consists essentially of casein glue.

23. A packaging blank according to claim 18, wherein said doped adhesive compound comprises less than 1.0 weight percent of said taggants.

24. A packaging blank according to claim 18 wherein said doped adhesive compound comprises between about 0.005 and 0.10 weight percent of said taggants.

25. A packaging blank according to claim 18, wherein said doped adhesive compound comprises between about 0.05 and 0.50 weight percent of said taggants.

26. A packaging blank according to claim 18, wherein said doped adhesive compound is selectively applied to portions of said packaging blank such that said taggants and said adhesive compound are substantially coextensive with respect to one another.

27. A packaging blank according to claim 18, wherein said doped adhesive compound is maintained and applied to said packaging blank at about room temperature.

28. A packaging blank according to claim 18, wherein the doped adhesive compound is heated and then applied to the packaging blank.

29. A packaging blank according to claim 18, wherein said taggants comprise phosphor.

30. A packaging blank according to claim 18, wherein the container formed from said blank includes one or more joints, said joints formed when a portion of at least one of said panels is secured to a portion of at least one of said flaps with said doped adhesive compound.

31. A packaging blank according to claim 18, further comprising an undoped adhesive compound selectively applied to portions of said packaging blank, wherein said undoped adhesive compound is applied to portions of said packaging blank other than said portions to which said doped adhesive compound is applied.
